(19) United States
(12) Patent Application Publication
(10) Pub. No.: US 2013/0275605 A1
(43) Pub. Date: Oct. 17, 2013

(54) ENGINEERING TOOL AND PROGRAMMABLE CONTROLLER

(71) Applicant: Yoshiaki Ikeda, Chiyoda-ku (JP)

(72) Inventor: Yoshiaki Ikeda, Chiyoda-ku (JP)

(73) Assignee: MITSUBISHI ELECTRIC CORPORATION, Chiyoda-ku, Tokyo (JP)

(21) Appl. No.: 13/993,906

(22) PCT Filed: Jan. 4, 2012
(86) PCT No.: PCT/JP2012/050038

§ 371 Date: Jun. 13, 2013

(30) Foreign Application Priority Data
Feb. 4, 2011 (JP) 2011-023236

(51) Int. Cl. H04L 29/06

(52) U.S. Cl. CPC H04L 65/1069
USPC 709/228

(57) ABSTRACT

An engineering tool and a programmable controller include a creation unit that converts a parameter of a transmission/reception area of a link device in a controller network into a parameter of a reception area of a reception link device and a parameter of a transmission area of a transmission link device in a field network based on a conversion law that is different between a master and a slave in the field network, thereby creating a parameter of a transmission/reception area of the link device in the field network.

### FIELD

The present invention relates to an engineering tool and a programmable controller.

### BACKGROUND

A programmable controller system includes a controller network and a field network. The controller network is a network having a principal purpose of transmitting and receiving control signals and data between programmable controllers. The field network is a network having a principal purpose of transmitting and receiving control signals and data between a programmable controller and a field device such as a remote input/output unit. In this programmable controller system, transmission and reception of control signals and data are realized by regularly updating a shared memory on a network and an internal memory of each programmable controller.

In the controller network, a transmission range of each node is allocated on a shared memory on the network. Each node writes control signals and data in an area of the shared memory allocated to the node itself, thereby transmitting data to the overall network. In addition, by referring to areas of the shared memory allocated to transmission ranges of other nodes, the node receives control signals and data from other nodes.

The field network is a network that performs transmission and reception of control signals and data between a node serving as a master and a node serving as a slave. The types of the node serving as a slave include a remote input/output device, a programmable controller, and the like. A case where the programmable controller is a slave is explained here. The programmable controller connected as a slave is referred to as “local station” as opposed to a master station. When the master station writes control signals and data in a data transmission area for each local station on a shared memory, the written control signals and data are stored in a data reception area of each local station, so that the control signals and data are transmitted. When each local station writes control signals and data in a data transmission area allocated to each node on the shared memory, the written control signals and data are stored in a data reception area of a master from each local station, so that the master station receives the control signals and data from each local station.

The field network can perform transmission and reception of control signals and data also between programmable controllers. In this case, data transmission and reception are performed by the method described above between a programmable controller serving as a master and a programmable controller other than a master. An area used for data transmission and reception is different in a case of performing data transmission and reception between programmable controllers other than a master. For example, when a programmable controller A other than a master and a programmable controller B other than a master perform data transmission and reception, the programmable controller A writes control signals and data in an area allocated as a data transmission area of the programmable controller A. The programmable controller B refers to the data transmission area of the programmable controller A, thereby receiving the control signals and data written by the programmable controller A. In this manner, when data transmission and reception are performed between programmable controllers in the field network, the area used for data transmission and reception is different between a case of performing data transmission and reception between a programmable controller serving as a master and a programmable controller other than a master and a case of performing data transmission and reception between programmable controllers other than a master.

### CITATION LIST

### Patent Literatures

Patent Literature 1: Japanese Patent Application Laid-open No. 2005-215936

Patent Literature 2: Japanese Patent Application Laid-open No. 2004-126817

### SUMMARY

### Technical Problem

While both the controller network and the field network can be used as a network that performs data transmission and reception between programmable controllers, in these networks, the concept of a data transmission area and a data reception area used for performing data transmission and reception is different. Therefore, for example, when a network system that performs data transmission and reception between programmable controllers through the controller network is replaced with a network system that performs data transmission and reception between programmable controllers through the field network, it is difficult to use a ladder program used in one network system also in the other one.

When a user who is accustomed to use a network system that performs data transmission and reception between programmable controllers through a controller network constructs a network system that performs data transmission and reception between programmable controllers through a field network, it is troublesome because the user needs to be strongly conscious to the differences in specifications between the controller network and the field network.

For example, when data transmission and reception are performed between programmable controllers in the field network, the area used for data transmission and reception is different between a case of performing data transmission and reception between a programmable controller serving as a master and a programmable controller other than a master and a case of performing data transmission and reception between programmable controllers other than a master. Accordingly, when a user constructs the network system that performs data transmission and reception between programmable controllers through the field network, the user needs to perform parameter setting and ladder programming while being conscious to the differences in specifications between the field network and the controller network. Consequently, it is difficult to efficiently develop network systems.

The present invention has been achieved in view of the above problems, and an object of the present invention is to provide an engineering tool and a programmable controller in which a user can construct a network system without being conscious to the differences in specifications between a controller network and a field network.

### Solution to Problem

There is provided an engineering tool and a programmable controller comprising a creation unit that converts a parameter of a transmission/reception area of a link device in a controller network into a parameter of a reception area of a reception link device and a parameter of a transmission area of a transmission link device in a field network based on a conversion law that is different between a master and a slave in the field network, thereby creating a parameter of a transmission/reception area of the link device in the field network.

### Advantageous Effects of Invention

According to the present invention, when a user performs communication between controllers using a field network, the user can specify a link device in a controller network. Accordingly, the user can construct a network system without being conscious to the differences in specifications between the controller network and the field network.

### BRIEF DESCRIPTION OF DRAWINGS

FIG. 1 depicts a configuration of an engineering tool according to an embodiment.

FIG. 2 depicts a flow of parameter automatic conversion in the embodiment.

FIG. 3 depicts a conversion law of a network-range allocation in the embodiment.

FIG. 4 depicts a creation law of an automatic refresh parameter (in a master station) in the embodiment.

FIG. 5 depicts a creation law of an automatic refresh parameter (in a local station) in the embodiment.

FIG. 6 is a flowchart of an operation of a programmable controller and an engineering tool according to the embodiment.

FIG. 7 depicts a programmable controller and an engineering tool according to a modification of the embodiment.

FIG. 8 is a flowchart of operations of the programmable controller and the engineering tool according to the modification of the embodiment.

### DESCRIPTION OF EMBODIMENTS

Exemplary embodiments of an engineering tool according to the present invention will be explained below in detail with reference to the accompanying drawings. The present invention is not limited to the embodiments.

### Embodiment

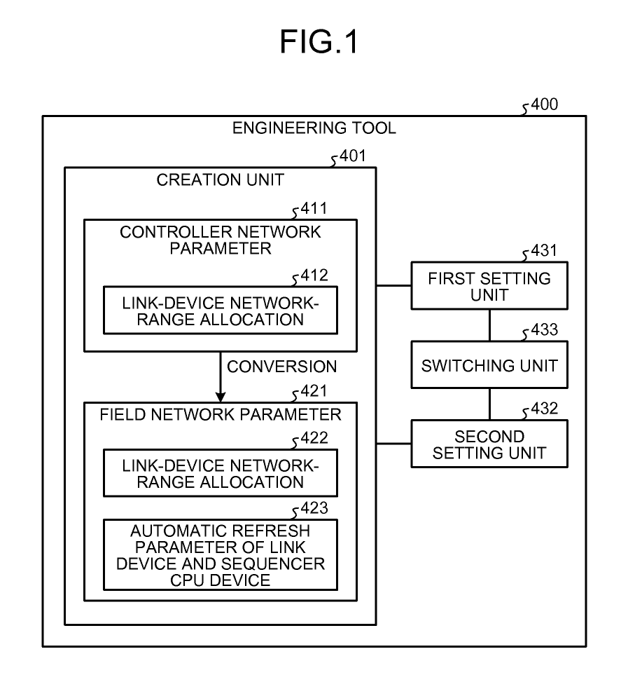

A configuration of an engineering tool 400 according to an embodiment is explained with reference to FIG. 1. FIG. 1 depicts an internal configuration (a functional configuration) of the engineering tool 400.

For example, in a programmable controller system in which a programmable controller (a master or a master station) and a plurality of programmable controllers (slaves or local stations) are connected to each other through a controller network and a field network, the engineering tool 400 is installed in an information processing apparatus (for example, a personal computer (not shown)) connected to be communicable with each programmable controller. The information processing apparatus creates a parameter (for example, a field network parameter 421 (described later)) using the engineering tool 400 and writes the created parameter in each programmable controller.

The engineering tool 400 includes a first setting unit 431, a creation unit (creation portion) 401, a second setting unit 432, and a switching unit (switching portion) 433. These constituent elements are constituent elements created in the information processing apparatus when, for example, the engineering tool 400 is executed in the information processing apparatus. These respective constituent elements can be created at a time when the engineering tool 400 is executed in the information processing apparatus or can be sequentially created at a timing when the respective constituent elements start their processes.

The first setting unit 431 receives a setting instruction of a link-device network-range allocation 412 that is a part of a controller network parameter 411 set by a user through an input unit such as a keyboard or a mouse, in a state where the first setting unit 431 itself is in a first setting mode (described later). A state where a user can set the controller network parameter 411 for the first setting unit 431 is referred to as “first setting mode”. The link-device network-range allocation 412 includes, for example, a parameter specifying a transmission/reception area of a link relay LB and a parameter specifying a transmission/reception area of a link register LW. The first setting unit 431 sets the link-device network-range allocation 412 according to the setting instruction from a user in the first setting mode and supplies the set setting information to the creation unit 401.

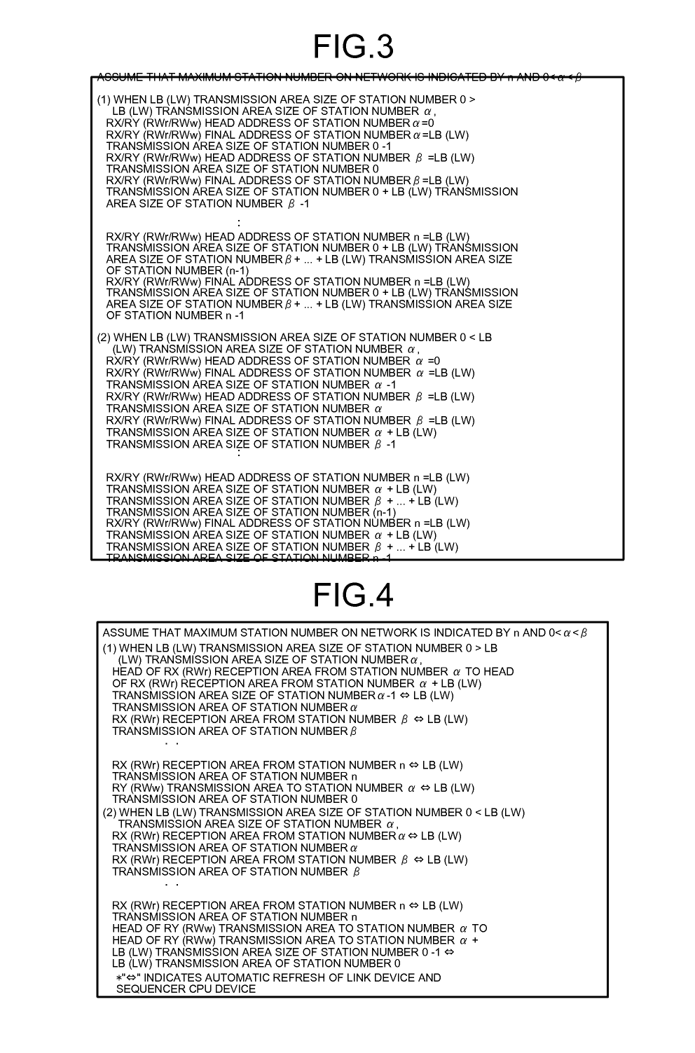

The creation unit 401 receives the link-device network-range allocation 412 set by the first setting unit 431 as the controller network parameter 411 when the first setting unit 431 is in the first setting mode. Next, the creation unit 401 converts the link-device network-range allocation 412 into a link-device network-range allocation 422 based on a conversion law shown in FIG. 3. The conversion law shown in FIG. 3 is a conversion law that is different between a master (a master station) and a slave (a local station) in a field network. That is, the conversion law shown in FIG. 3 is set so that a link-device specification method is the same in both a case where two communicating programmable controllers have a master-slave relationship and a case where two communicating programmable controllers have a slave-slave relationship.

The link-device network-range allocation 422 converted in the creation unit 401 described above includes, for example, a parameter specifying a reception area of a reception link device and a parameter specifying a transmission area of a transmission link device. The parameter of the reception area of the reception link device includes, for example, a parameter specifying a reception area of a remote input RX and a parameter specifying a reception area of a remote register RWr. The parameter specifying the transmission area of the transmission link device includes, for example, a parameter specifying a transmission area of a remote output RY and a parameter specifying a transmission area of a remote register RWw. In this manner, the creation unit 401 creates the link-device network-range allocation 422 as a part of the field network parameter 421.

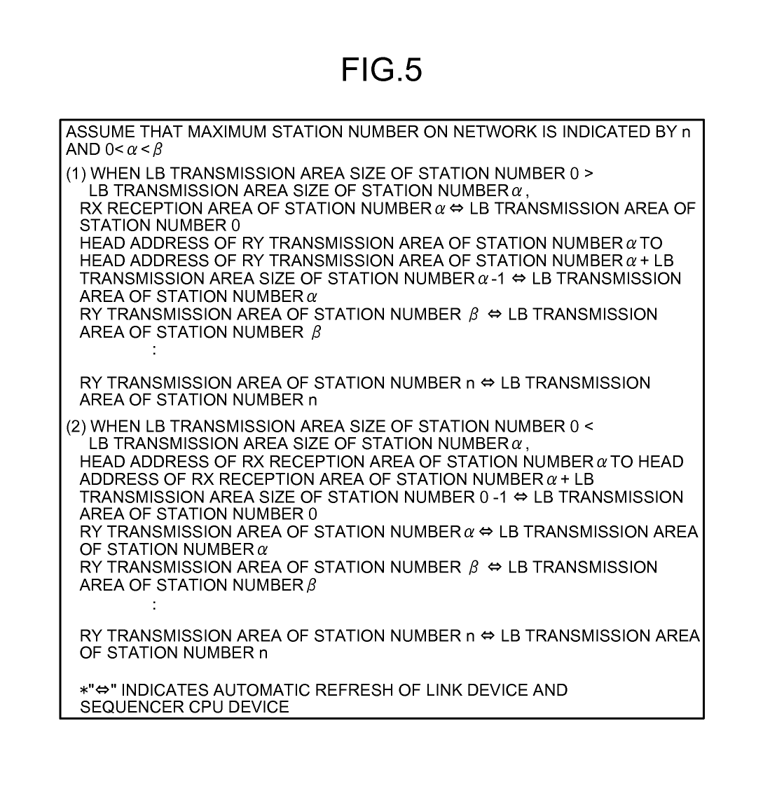

Furthermore, when the first setting unit 431 is in the first setting mode, the creation unit 401 creates an automatic refresh parameter 423 of a link device and a sequencer CPU that is a parameter for automatically updating the link device and the sequencer CPU device, for example, periodically as another part of the field network parameter 421 using the converted link-device network-range allocation 422 based on a creation law shown in FIG. 4 or FIG. 5. The creation law shown in FIG. 4 or FIG. 5 is a creation law that is different between a master (a master station) and a slave (a local station) in a field network. That is, the creation law shown in FIG. 4 or FIG. 5 is set so that a link-device specification method is the same in both the case where two communicating programmable controllers have a master-slave relationship and the case where two communicating programmable controllers have a slave-slave relationship. The creation law shown in FIG. 4 is used for a case where the engineering tool 400 creates a parameter of a programmable controller (a master station) and the creation law shown in FIG. 5 is used for a case where the engineering tool 400 creates a parameter of a programmable controller (a local station).

The second setting unit 432 receives a setting instruction of the field network parameter 421 from a user through the input unit such as a keyboard or a mouse in a state where the second setting unit 432 itself is in a second setting mode (described later). A state where a user can set the field network parameter 421 for the second setting unit 432 is referred to as “second setting mode”. The second setting unit 432 sets the field network parameter 421 according to the setting instruction from the user in the second setting mode and supplies the setting information to the creation unit 401.

In response thereto, the creation unit 401 receives and holds the field network parameter 421 set by the second setting unit 432 in the second setting mode. In this example, because the field network parameter 421 received by the creation unit 401 is a parameter input in advance by a user as a field network parameter, the field network parameter 421 can be used as it is.

The switching unit 433 switches between the first setting unit 431 and the second setting unit 432, thereby switching between the first setting mode and the second setting mode. The first setting mode is a setting mode by a controller network parameter, and is a mode in which the controller network parameter 411 is set by the first setting unit 431 according to the setting instruction from a user. The second setting mode is a setting mode by a field network parameter, and is a mode in which the field network parameter 421 is set by the second setting unit 432 according to the setting instruction from a user. These two modes can be arbitrarily switched by the user using the engineering tool 400 (as the switching unit 433 receives a switching instruction from the user).

Furthermore, a parameter that is set by the user as the controller network parameter 411 in the setting mode (the first setting mode) of the engineering tool 400 by the controller network parameter 411 and that is converted into the field network parameter 421 in the engineering tool 400 can be converted again into the controller network parameter 411 using the engineering tool 400.

Further, the user arbitrarily switches between the first setting mode and the second setting mode by the switching unit 433 for the field network parameter 421 read from a programmable controller so as to set a parameter.

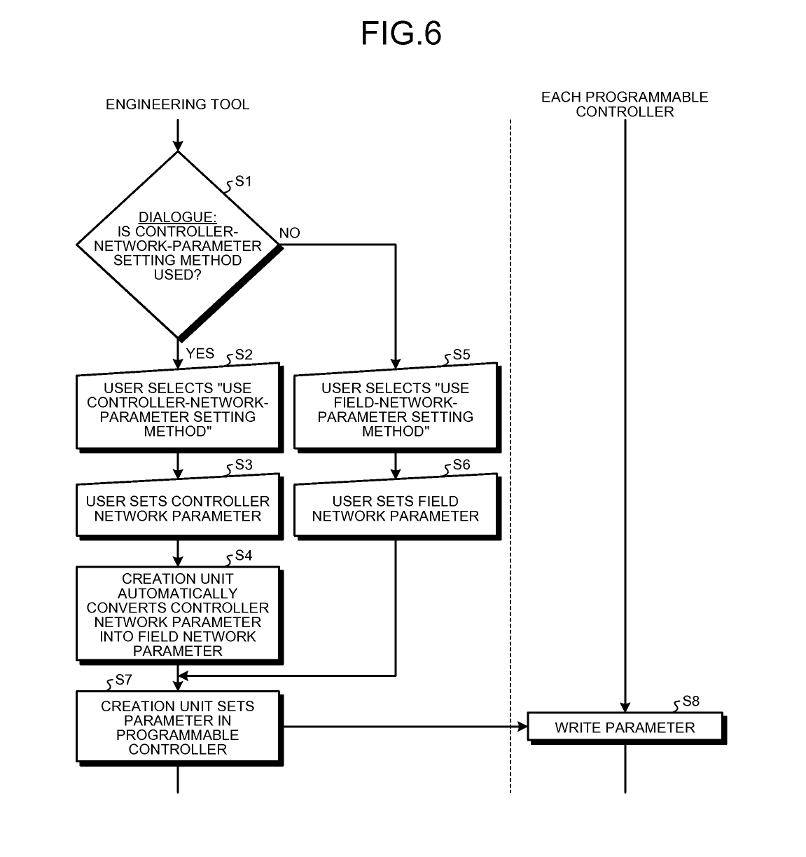

Next, an operation of a programmable controller and the engineering tool 400 is explained with reference to FIG. 6. FIG. 6 is a flowchart of an operation of a programmable controller and the engineering tool 400.

At Step S1, the engineering tool 400 displays a dialogue screen that inquires a user whether a controller-network-parameter setting method is used on a display unit (for example, a display device) of the information processing apparatus. Thereafter, when the engineering tool 400 receives an instruction of using the controller-network-parameter setting method through an input unit (for example, a keyboard or a mouse) of the information processing apparatus (YES at Step S1), the process proceeds to Step S2. When the engineering tool 400 receives an instruction of not using the controller-network-parameter setting method through the input unit of the information processing apparatus (NO at Step S1), the process proceeds to Step S5.

At Step S2, the engineering tool 400 recognizes that the user has selected “use controller-network-parameter setting method” and notifies its recognized content to the switching unit 433. In response to this notification, when the current setting mode is the first setting mode, the switching unit 433 does not change the mode, and when the current setting mode is another setting mode (for example, the second setting mode), the switching unit 433 switches from the current setting mode to the first setting mode. The switching unit 433 then notifies the first setting unit 431 that the current setting mode is the first setting mode.

At Step S3, in response to the notification that the current setting mode is the first setting mode, the first setting unit 431 is in a state of being capable of receiving the controller network parameter 411 from the user. With this process, the first setting unit 431 receives a setting instruction of the controller network parameter 411. For example, the first setting unit 431 receives the setting instruction of the link-device network-range allocation 412. The link-device network-range allocation 412 includes, for example, a parameter specifying the transmission/reception area of the link relay LB and a parameter specifying the transmission/reception area of the link register LW. The first setting unit 431 sets the link-device network-range allocation 412 according to the setting instruction from the user and supplies the setting information to the creation unit 401.

At Step S4, the creation unit 401 receives the link-device network-range allocation 412 set by the first setting unit 431 as the controller network parameter 411. The creation unit 401 converts (automatically converts) the link-device network-range allocation 412 into the link-device network-range allocation 422 based on the conversion law shown in FIG. 3. The link-device network-range allocation 422 includes, for example, a parameter specifying the reception area of the reception link device and a parameter specifying the transmission area of the transmission link device. The parameter of the reception area of the reception link device includes, for example, a parameter specifying the reception area of the remote input RX and a parameter specifying the reception area of the remote register RWr. The parameter specifying the transmission area of the transmission link device includes, for example, a parameter specifying the transmission area of the remote output RY and a parameter specifying the transmission area of the remote register RWw. In this manner, the creation unit 401 creates the link-device network-range allocation 422 as a part of the field network parameter 421.

Furthermore, the creation unit 401 creates the automatic refresh parameter 423 of a link device and a sequencer CPU that is a parameter for automatically updating the link device and the sequencer CPU device, for example, periodically as another part of the field network parameter 421 using the created link-device network-range allocation 422 based on the creation law shown in FIG. 4 or FIG. 5.

At Step S5, the engineering tool 400 recognizes that the user has selected “use field-network-parameter setting method” and notifies its recognized content to the switching unit 433. In response to this notification, when the current setting mode is the second setting mode, the switching unit 433 does not change the mode, and when the current setting mode is another setting mode (for example, the first setting mode), the switching unit 433 switches from the current setting mode to the second setting mode. The switching unit 433 notifies the first setting unit 431 that the current setting mode is the second setting mode.

At Step S6, in response to the notification that the current setting mode is the second setting mode, the second setting unit 432 is in a state of being capable of receiving the field network parameter 421 from the user. With this process, the second setting unit 432 receives the setting instruction of the field network parameter 421. For example, the second setting unit 432 receives the setting instruction of the link-device network-range allocation 422. Alternatively, for example, the second setting unit 432 receives a setting instruction of the automatic refresh parameter 423 of a link device and a sequencer CPU. The second setting unit 432 sets the field network parameter 421 according to the setting instruction from the user and supplies the setting information to the creation unit 401.

In response thereto, the creation unit 401 receives the field network parameter 421 set by the second setting unit 432. The creation unit 401 can use the received field network parameter 421 as it is.

At Step S7, the creation unit 401 transmits the field network parameter 421 that is created (or used as it is) and its write command to each programmable controller via a communication interface and a communication line.

At Step S8, each programmable controller receives the field network parameter 421 and its write command via a communication line and writes the field network parameter 421 in a predetermined area of an internal memory. With this process, the field network parameter 421 is written in each programmable controller.

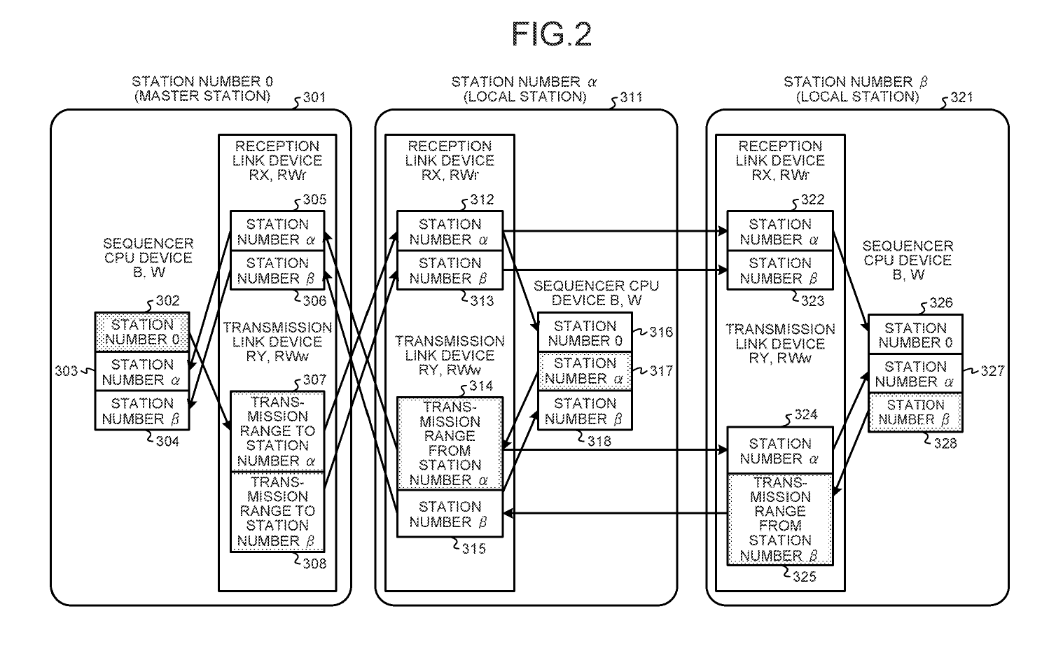

Next, a parameter automatic conversion function in the creation unit 401 of the engineering tool 400 is explained. FIG. 2 depicts a flow in which the parameter automatic conversion function of an engineering tool converts a controller network parameter set by a user into a field network parameter. A configuration of three stations, which are a station number 0 (a master station) 301, a station number α (a local station) 311, and a station number β (a local station) 321, is described as an example in FIG. 2. While the station number 0 is a master station in the present embodiment, the master station is not limited to the station number 0. The master station can be any station number as long as it can be the reference of an ascending order or a descending order with respect to the station number α and the station number β, which serve as local stations.

In this explanation, it is assumed that 0<α<β. The station number 0 (a master station) 301 includes controller-network transmission areas 302 to 304, field-network reception areas 305 and 306, and field-network transmission areas 307 and 308. The station number α (a local station) 311 includes controller-network transmission areas 316 to 318, field-network reception areas 312 and 313, and field-network transmission areas 314 and 315. The station number β (a local station) 321 includes controller-network transmission areas 326 to 328, field-network reception areas 322 and 323, and field-network transmission areas 324 and 325.

A parameter conversion method in the station number 0 (a master station) 301 is described here. A user sets a link-device network-range allocation for setting a transmission range of each node on a network as a controller network parameter. In the example of the three-station configuration of FIG. 2, it is assumed that the transmission area 302 of the station number 0, the transmission area 303 of the station number α, and the transmission area 304 of the station number β are set. The engineering tool 400 converts the set controller network parameter into a link-device range-allocation parameter that is a field network parameter based on the conversion law shown in FIG. 3. Furthermore, the engineering tool 400 creates an automatic refresh parameter for automatically updating a link device and a sequencer CPU device, for example, periodically using the link-device range-allocation parameter based on the creation law shown in FIG. 4.

A parameter conversion method in the station number α (a local station) 311 is described next. The engineering tool 400 creates an automatic refresh parameter for automatically updating a link device and a sequencer CPU device, for example, periodically from the controller network parameter set for the station number 0 (a master station) 301 based on the creation law shown in FIG. 5.

A parameter conversion method in the station number β (a local station) 321 is described here. Similarly to the station number α (a local station) 311, the engineering tool 400 creates an automatic refresh parameter for automatically updating a link device and a sequencer CPU device, for example, periodically from the controller network parameter set for the station number 0 (a master station) 301 based on the creation law shown in FIG. 5.

Next, a flow at the time of performing data transmission and reception between programmable controllers when the parameter conversion descried above is used is explained.

A case where the station number 0 (a master station) 301 transmits data to other stations is described here. When the station number 0 (a master station) 301 writes data in the transmission area 302 of a controller network parameter, it is assumed that data is written in the transmission area 307 of a field network parameter to the station number α (a local station) 311. The station number α (a local station) 311 then receives data in the reception area 312 of the field network parameter. The received data is converted into the transmission area 316 of the controller network parameter for the station number 0 (a master station) 301.

As explained above, it is assumed that that data written by the station number 0 (a master station) 301 in the transmission area 302 of the master station 301 itself is received by the station number α (a local station) 311 in the transmission area 316 for the station number 0 (a master station) 301. Similarly, it is assumed that that data written by the station number 0 (a master station) 301 in the transmission area 302 of the controller network parameter is received by the station number β (a local station) 321 in the transmission area 326 for the station number 0 (a master station) 301.

A case where the station number α (a local station) 311 transmits data to other stations is described here. When the station number α (a local station) 311 writes data in the transmission area 317 of a controller network parameter, it is assumed that data is written in the transmission area 314 of a field network parameter from the station number α (a local station) 311. Therefore, the station number 0 (a master station) 301 receives data in the reception area 305 of the field network parameter. The received data is converted into the transmission area 303 of the controller network parameter for the station number α (a local station) 311.

As explained above, it is assumed that data written by the station number α (a local station) 311 in the transmission area 317 of the local station 311 itself is received by the station number 0 (a master station) 301 in the transmission area 303 for the station number α (a local station). Similarly, it is assumed that data written by the station number α (a local station) 311 in the transmission area 317 of the controller network parameter is received by the station number β (a local station) 321 in the transmission area 327 of the field network parameter for the station number α (a local station) 311.

A case where the station number β (a local station) 321 transmits data to other stations is described here. When the station number β (a local station) 321 writes data in the transmission area 328 of the controller network parameter, it is assumed that data is written in the transmission area 325 of the field network parameter from the station number β (a local station) 321. The station number 0 (a master station) 301 thus receives data in the reception area 306 of the field network parameter. The received data is converted into the transmission area 304 of the controller network parameter for the station number β (a local station) 321.

As explained above, it is assumed that that data written by the station number β (a local station) 321 in the transmission area 328 of the local station 321 itself is received by the station number 0 (a master station) 301 in the transmission area 304 for the station number β (a local station) 321. Similarly, it is assumed that data written by the station number β (a local station) 321 in the transmission area 328 of the controller network parameter is received by the station number α (a local station) 311 in the transmission area 318 of the field network parameter for the station number β (a local station) 321.

As explained above, according to the automatic parameter-conversion function in the engineering tool of the present embodiment, conversion of automatically allocating an area specified by a user as a data transmission/reception area when a controller network is used to a data transmission/reception area when a field network is used is performed, thereby automatically creating a field network parameter. That is, parameter conversion is performed on a parameter set as the data transmission/reception area when the controller network is used based on a conversion law that is different between a programmable controller serving as a master station and a programmable controller other than a master. In other words, association of the link device LB or LW with the transmission/reception link device RWw or RWr is performed in an engineering tool that writes a parameter in a programmable controller, thereby automatically creating a parameter. With this configuration, when the user performs communication between controllers using the field network, the link device LB or LW of the controller network can be specified. Accordingly, when the user performs the communication between controllers using the field network, the user can perform parameter setting and programming similarly to a case of using the controller network. As a result, the user can construct a network system without being conscious to the differences in specifications between the controller network and the field network.

Because firmware does not need to be changed on a side of a programmable controller, the functions described above can be used only by a version upgrade of an engineering tool in the programmable controller.

Furthermore, a parameter newly set by a user as a controller network parameter can be converted into a field network parameter by the engineering tool in an additional manner or by updating. Accordingly, even when the controller network is managed as the field network because a system is added, changed, and the like, such a case can be easily handled.

According to the parameter automatic conversion function in the engineering tool of the present embodiment, an automatic refresh parameter that is a parameter for automatically updating a link device and a sequencer CPU device periodically is created using the created field network parameter based on a creation law that is different between a programmable controller serving as a master station and a programmable controller other than a master station. That is, by two parameters, which are a link-device network-range allocation and an automatic refresh parameter, a user specifies the data transmission/reception area when the controller network is used through a sequencer CPU device, thereby performing data transmission and reception between programmable controllers.

As shown by a broken line in FIG. 1, after the controller network parameter is converted into the field network parameter, the creation unit 401 can convert again the field network parameter into the controller network parameter. With this configuration, even when the field network is managed as the controller network, such a case can be easily handled.

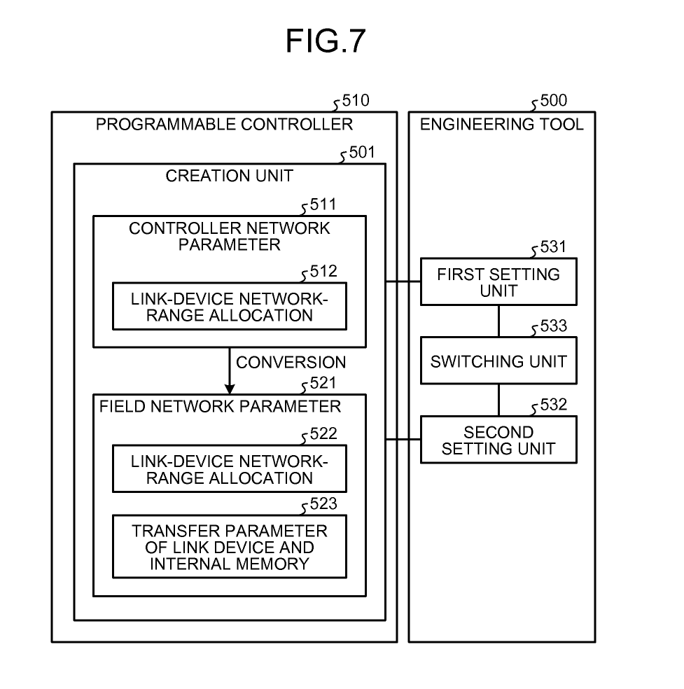

As a modification of the present embodiment, a creation unit 501 can be incorporated in a programmable controller. A configuration example of this case is shown in FIG. 7. In this case, a controller network parameter 511 received in a first setting unit 531 of an engineering tool 500 is supplied to the creation unit 501 of a programmable controller 510. The creation unit 501 converts the supplied controller network parameter 511 into a field network parameter 521, based on the conversion law shown in FIG. 3, FIG. 4, or FIG. 5. When the programmable controller 510 includes the creation unit 501, a link-device network-range allocation 522 and a transfer parameter 523 of a link device and an internal memory are created as the field network parameter 521. The conversion law of the link-device network-range allocation 522 is equivalent to the formulas shown in FIG. 3. The conversion law of the transfer parameter 523 of a link device and an internal memory is equivalent to the formulas shown in FIGS. 4 and 5. The modification is also identical to the above embodiment in a feature that a switching unit 533 switches between the first setting mode and the second setting mode.

As described above, by a mode of providing the creation unit 501 in the programmable controller 510, even when an engineering tool that does not include the creation unit 401 (see FIG. 1) is used, the creation unit 501 in the programmable controller is used so as to use the function of performing parameter conversion between the controller network parameter and the field network parameter.

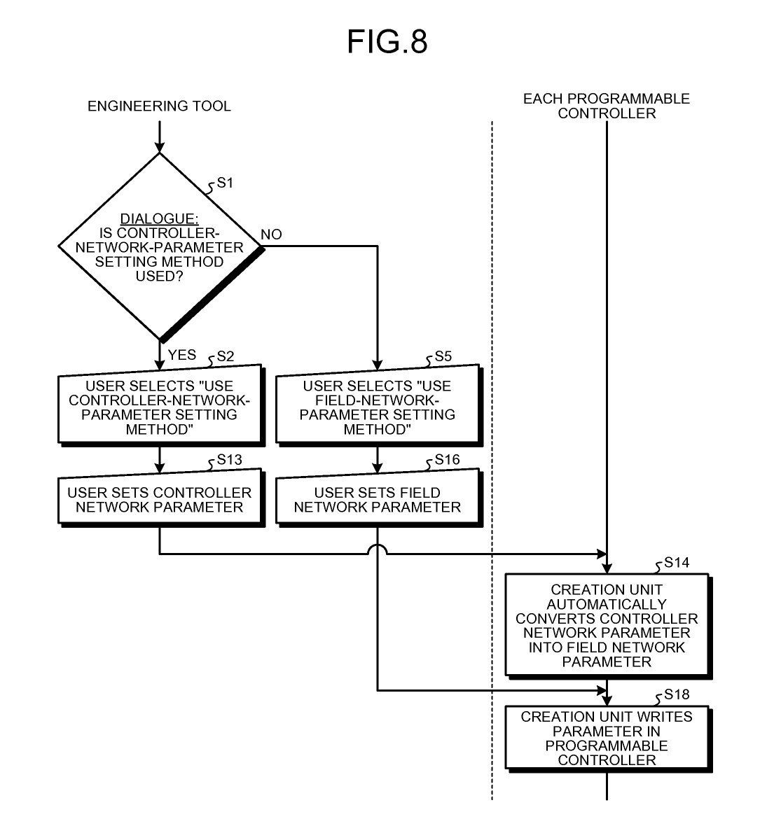

Furthermore, in this case, as shown in FIG. 8, operations of the programmable controller and the engineering tool 500 are different from those of the above embodiment in the following points.

At Step S13, the first setting unit 531 performs processes identical to those of Step S3. Thereafter, setting information of the controller network parameter 511 is transmitted via a communication interface and a communication line to each programmable controller.

At Step S14, each programmable controller receives the setting information of the controller network parameter 511 including a link-device network-range allocation 512 via a communication line. Each programmable controller supplies the received setting information of the controller network parameter 511 to the creation unit 501. The creation unit 501 converts the supplied controller network parameter 511 into the field network parameter 521 based on the conversion law shown in FIG. 3, FIG. 4, or FIG. 5. As the field network parameter 521, the link-device network-range allocation 522 and the transfer parameter 523 of a link device and an internal memory are created.

At Step S16, a second setting unit 532 performs processes identical to those of Step S6. Thereafter, setting information of the field network parameter 521 is transmitted via a communication interface and a communication line to each programmable controller.

At Step S18, when each programmable controller receives the setting information of the field network parameter 521 via a communication line, the received setting information of the field network parameter 521 is supplied to the creation unit 501. The creation unit 501 writes the field network parameter 521 created at Step S14 or the received field network parameter 521 in a predetermined area of an internal memory. With this operation, the field network parameter 521 is written in each programmable controller.

As described above, according to the modification of the above embodiment, because a write command does not need to be transmitted from an engineering tool (an information processing apparatus) to each programmable controller, the amount of transmitted information can be reduced as compared to the above embodiment.

### INDUSTRIAL APPLICABILITY

As described above, the engineering tool and the programmable controller according to the present invention are useful for a programmable controller system.

### REFERENCE SIGNS LIST

301 station number 0 (master station)

302 to 304 controller-network transmission area

305, 306 field-network reception area

307, 308 field-network transmission area

311 station number α (local station)

312, 313 field-network reception area

314, 315 field-network transmission area

316 to 318 controller-network transmission area

321 station number β (local station)

322, 323 field-network reception area

324, 325 field-network transmission area

326 to 328 controller-network transmission area

400 engineering tool

401 creation unit

411 controller network parameter

412 link-device network-range allocation

421 field network parameter

422 link-device network-range allocation

423 automatic refresh parameter of link device and sequencer CPU device

431 first setting unit

432 second setting unit

433 switching unit

500 engineering tool

501 creation unit

510 programmable controller

511 controller network parameter

512 link-device network-range allocation

521 field network parameter

522 link-device network-range allocation

523 transfer parameter of link device and internal memory

531 first setting unit

532 second setting unit

533 switching unit

1. An engineering tool comprising
a creation unit that converts a parameter of a transmission/reception area of a link device in a controller network into a parameter of a reception area of a reception link device and a parameter of a transmission area of a transmission link device in a field network based on a conversion law that is different between a master and a slave in the field network, thereby creating a parameter of a transmission/reception area of the link device in the field network.

2. The engineering tool according to claim 1, wherein
the conversion law is set so that a link-device specification method is equivalent in both communication between a master and a slave and communication between a slave and a slave in the field network.

3. The engineering tool according to claim 1, wherein
the creation unit creates a refresh parameter for automatically updating a link device and a sequencer CPU device using the created parameter based on a creation law that is different between the master and the slave in the field network.

4. The engineering tool according to claim 3, wherein
the creation law is set so that a link-device specification method is equivalent in both communication between a master and a slave and communication between a slave and a slave in the field network.

5. The engineering tool according to claim 1, further comprising
a switching unit that switches between a first setting mode of setting a parameter of a transmission/reception area of a link device in the controller network and a second setting mode of setting a parameter of a transmission/reception area of a link device in the field network.

6. The engineering tool according to claim 3, further comprising
a switching unit that switches between a first setting mode of setting a parameter of a transmission/reception area of a link device in the controller network and a second setting mode of setting a parameter of a transmission/reception area of a link device in the field network.

7. A programmable controller comprising
a creation unit that converts a parameter of a transmission/reception area of a link device in a controller network into a parameter of a reception area of a reception link device and a parameter of a transmission area of a transmission link device in a field network based on a conversion law that is different between a master and a slave in the field network, thereby creating a parameter of a transmission/reception area of the link device in the field network.

8. The programmable controller according to claim 7, wherein
the conversion law is set so that a link-device specification method is equivalent in both communication between a master and a slave and communication between a slave and a slave in the field network.

9. The programmable controller according to claim 7, wherein
the creation unit creates a refresh parameter for automatically updating a link device and a sequencer CPU device using the created parameter based on a creation law that is different between the master and the slave in the field network.

10. The programmable controller according to claim 9, wherein
the creation law is set so that a link-device specification method is equivalent in both communication between a master and a slave and communication between a slave and a slave in the field network.
